(19) United States
(12) Patent Application Publication
(10) Pub. No.: US 2010/0281642 A1
(43) Pub. Date: Nov. 11, 2010

(54) TELESCOPIC DEVICES HAVING MULTIFUNCTIONAL ATTACHMENTS

(76) Inventor: Jimmy Lee, New York, NY (US)

Correspondence Address: DUANE MORRIS LLP - Atlanta;IP DEPARTMENT, ATLANTIC CENTER PLAZA, 1180 WEST PEACHTREE STREET, NW SUITE 700, ATLANTA, GA, 30309-3348, US

(21) Appl. No.: 12/775,934

(22) Filed: May 7, 2010

Related U.S. Application Data
(60) Provisional application No. 61/215,477, filed on May 7, 2009.

(51) Int. Cl. A47L 9/32; B25G 1/04

(52) U.S. Cl. 15/144.4; 16/404; 16/429

(57) ABSTRACT

A representative telescopic device includes a housing, a telescopic stick, and an attachment system. The telescopic stick is configured to be housed in the housing in a closed position. The telescopic stick includes one or more segments that is configured to extend into an elongated stick in an extended position. The attachment system is attached to an end of the telescopic stick. The attachment system includes a locking mechanism that locks and unlocks an attachment to the telescopic stick. The attachment system further includes an attachment actuation mechanism that opens and closes the attachment.

### CROSS REFERENCE TO RELATED APPLICATIONS

This application claims the benefit of U.S. Provisional Patent Application No. 61/215,477, filed May 7, 2009, entitled “Collection Device,” which is entirely incorporated herein by reference.

### TECHNICAL FIELD

The present disclosure relates generally to telescopic devices, and more specifically to a telescopic device having multifunctional attachments.

### BACKGROUND

Currently, there are many cumbersome cleaning and collection devices that are used for indoor household cleaning, lawn and garden care, animal and pet waste removal, and other similar cleanup activities.

Current devices for indoor household cleaning (e.g., mops, brooms, brushes, vacuums, etc.), lawn and garden care (rakes, hoe, broom, sweeper), and animal and pet waste removal (“pooper scooper” and plastic bags), employ long sticks that are typically around 4-5 feet in length, and often made of solid wood, plastic, or metal and are not foldable and/or compact, and have end attachments attached to the stick (e.g., mop head, broom head, etc.). These devices, while providing decent functionality, provide poor storage convenience where users often have to own multiple products for different collection and cleaning purposes, and such products create cumbersome and unsightly storage in a closet or garage (“closet or garage clutter”).

In the field of collapsible cleaning devices, U.S. Pat. No. 5,943,727 employs an accordion like collapsible structure. However, attachments disclosed in the U.S. Pat. No. 5,943,727 do not have any actuation systems that allow the stick, handle, or attachment to be moved or pivoted, automatically or manually, for a better positioning of that product.

U.S. Pat. No. 5,887,314 has a manually adjusted telescopic handle that is created by using independent external segments that are twisted and tied to each other before use. The manual adjustment of the telescopic handle can be undesirable to a user.

Specifically in the area of dog waste scoopers, U.S. Patent Application Publication No. US 2007/0085357 is focused on scooping devices where a user utilizes the scooping devices to drag along the ground to pick up dog waste. U.S. Pat. No. 7,198,310 uses a scooping device that is not telescopic and has a built in closing system. US 2006/0237978; U.S. Pat. No. 6,941,896; and U.S. Pat. No. 7,040,677 have devices with similar characteristics and features as in U.S. Pat. No. 7,198,310.

Specifically in the area of dog waste catchers, U.S. Pat. No. 7,631,910 employs a telescopic stick that, has segments that are rotational. In addition, U.S. Pat. No. 7,631,910 has a holder for a disposable receptacle that is fixed and built onto the telescopic stick, and whereby the receptacle is placed into the holder. In addition, this fixed receptacle holder and disposable receptacle are very big in size, and unable to lay flat on the ground, thus not being able to be used on dogs that crouch a few inches to the ground to defecate.

U.S. Pat. No. 7,090,268 employs a single, solid stick and has a fixed loop holder built into the stick. U.S. Pat. Nos. 6,039,370; 6,702,349; 4,852,924; 7,204,532; 3,744,453; 4,010,970; and US 2007/0029828 have devices with similar characteristics and features as in U.S. Pat. No. 7,090,268 and U.S. Pat. No. 7,090,268.

### SUMMARY

A representative telescopic device includes a housing, a telescopic stick, and an attachment system. The telescopic stick is configured to be housed in the housing in a closed position. The telescopic stick includes one or more segments that is configured to extend into an elongated stick in an extended position. The attachment system is attached to an end of the telescopic stick. The attachment system includes a locking mechanism that locks and unlocks an attachment to the telescopic stick. The attachment system further includes an attachment actuation mechanism that opens and closes the attachment.

The telescopic device can be a collection and cleaning device that includes a telescopic stick, attachment mechanism, and multiple attachments to be used for multiple applications. The collection and cleaning device allows a user to automatically or manually adjust the position of the telescopic stick and, or, the attachment, for better ease of use. This collection and cleaning device has additional features including a carrying mechanism, light, and telescopic stick locking and unlocking system, and non-rotational features, to provide additional functionality and user convenience

The collection and cleaning device can include a light weight and durable telescopic stick with an attachment mechanism that allows various functional attachments to be inserted and used with the stick in a compact or extended position.

The attachment mechanism can include a locking and unlocking feature that allows different attachments such as, but not limited to, a frame and bag, rake, broom, mop, or cleaning pad, which can then be used for a variety of traditional and nontraditional indoor household cleaning, lawn and garden care, animal or pet waste cleanup, or other similar clean up type activities.

The telescopic stick can be automatically or manually extended to a desired length of use and consists of locking, or lock-like features, as well as non-rotational features which allow the telescopic stick maintain its straightened form so it doesn't collapse or rotate when in use. Another feature allows a user to automatically or manually adjust the telescopic stick, handle, or attachment to a more desired angle or position for easier use and functionality. In addition, another feature allows the opening and closing of attachments before, during, and after use.

The collection and cleaning device can also have additional features that provide additional convenience and usability including a carrying mechanism which allows a user to attach the collection and cleaning device to another object for ease of transport or storage (such as to an article of clothing, a part of a person's body, a dog leash or other type item), an ergonomic handle with grip-like texture, a light for use in dark areas or at night, and an attachment holding and carrying mechanism.

The collection and cleaning device can be a compact telescopic stick (typically but not limited to a length of 6-24 inches) which can be automatically or manually extended to a longer desired length (typically but not limited to a length of 2-7 feet). The telescopic stick of the collection and cleaning device has an attachment system that allows for the attachment of multiple other objects such as, but not limited to, a frame with a bag, rake, mop, or broom. The multifunctional attachment allows a user to own just one collection and cleaning device and have multiple attachments, instead of owning multiple long stick based form products to conduct multiple cleaning activities. In addition, the compaction and extension nature of the product allows a greater degree of storage and transportation convenience, and eliminates the usual closet and garage clutter associated with owning multiple cleaning tools (rakes, mops, brooms, etc.), that cannot be compacted or folded up. The compact nature of the collection and cleaning allows a user to compact the device and its attachments, and store it in a drawer, on a coat hanger, small storage bag, dog leash, or other small storage type area.

In the area of indoor household cleaning, consumers often own multiple long, stick based products with built-in attachments such as a mop, broom, vacuum, sweeper, and cleaning pad tool to clean their carpets and hard surface floors. The collection and cleaning device allows a user to eliminate the ownership of multiple products by owning just one device (the disclosure) and owning multiple replacement attachments that can be attached and detached upon and after use. These attachments may also be disposable in nature after one, or multiple uses.

In the area of lawn and garden care, and other outside cleanup activities, consumers often own multiple long, stick based products with built-in attachments such as a rake, broom, or hoe to manage outdoor clean activities such as raking leaves, turning soil for gardening, and brushing sidewalks and driveways. The collection and cleaning device allows a user to eliminate the ownership of multiple products by owning just one device (the disclosure) and owning multiple replacement attachments that can be attached and detached upon and after use. These attachments may also be disposable in nature after one, or multiple uses.

In the area of pet and animal waste cleanup, some current dog owners use a traditional “pooper scooper” for backyard clean up that is composed of a rake and shovel type device either assembled together or used independently. A dog owner, owning a backyard, typically lets their dog defecate in their backyard, and then uses a pooper scooper type device (rake and shovel) to remove and dispose of their dog's waste. This method is often deemed disgusting and unsanitary as dog waste residue is often left on the rake and shovel, and is further compounded by the owner's inability to store the rake and shovel in a convenient area (e.g. “where do you put it?”). In addition, dog waste residue contains viruses and bacteria which are harmful to both the environment and human health. The collection and cleaning device allows a user to attach a rake on one stick and a bag on another, and rake the dog's waste into the bag, and dispose of both the rake and bag after use. After the dog owner is done using the disclosure, the owner can retract the stick and store it in a compact area. The dog owner never has to worry about dog waste exposed on a shovel and rake, and can conveniently compact the disclosure and store it in a small area such as a hook in a garage or storage pouch.

The disclosure also targets another application in animal and pet waste management where the disclosure is used not as a dog “pooper scooper”, but more as a dog “pooper catcher”. While many dog owners may own a backyard where they let their dogs defecate, many dog owners, such as those living in cities, or those that take their dogs on walks on sidewalks, must clean their dog's waste off concrete sidewalks. Dog waste removal from concrete sidewalks is often done by dog owners putting their hand in a plastic bag, bending over to pick up their dog's waste through their hand in the plastic bag, and then carrying the bag and disposing it in a garbage can. This “hand in the plastic bag” approach is often deemed disgusting, inconvenient, embarrassing, and often physically challenging, especially for older dog owners. The collection and cleaning device allows a user an alternative to this “hand in the plastic bag” approach, where by a user attaches a collection attachment, such as a frame and bag attachment, to the device, pushes a button to extend the telescopic stick, slides the frame and bag attachment under the dog while it defecates, retract the stick, detach the bag, and throw it away. The collection and cleaning device provides a dog owner with a significantly more convenient, sanitary, and environmentally friendly method versus the “hand in the plastic bag” approach. The dog owner never has to bend over, pick up, or touch their dog's waste.

Other uses of the disclosure in pet and animal care waste management include cat waste removal from kitty litter boxes by employing a framed type bag and scoop attachment, where the cat owner can insert the attachment, extend the telescopic stick and remove the cat's waste without having to bend over or get close to scooping up the cat's waste. Cleaning cat waste from kitty litter boxes is often considered disgusting and gross, where a user has to bend over, and scoop cat waste from the kitty litter box.

While the collection and cleaning device can be used for indoor household cleaning, lawn and garden care, outdoor cleaning, and animal and pet waste management as described above, it can be used for any clean up activity that may require a similar functioning product or tool, such as indoor and outdoor sanitation removal (e.g. broom and bag cleanup activities in parks, museums, sports stadiums and arenas, etc.).

In the field of animal and dog waste management, the user may also insert the bag and frame attachment where it is inserted “upside down” where the opening of the bag faces the ground, and whereby a user presses a button that automatically closes the bag while the telescopic stick is in closed or extended position and “snaps” up the dog waste from the ground.

All of the disclosure's features are dedicated to providing a user with a higher degree of sanitation and convenience in managing cleanup activities both when in use and in storage.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a telescopic device in its compact form in accordance with the present disclosure;

FIG. 2 is a rear view of a telescopic device, such as that shown in FIG. 1;

FIG. 3 is a front, angled view of a telescopic device, such as that shown in FIG. 1, having a frame and bag attachment;

FIG. 4 is a perspective view of a telescopic device, such as that shown in FIG. 3, in its extended form having a frame and bag attachment;

FIG. 5 is a cross-sectional view of a telescopic stick spring system housed in a telescopic device, such as that shown in FIG. 1;

FIG. 6 is a cross-sectional view of an opening mechanism of a telescopic device, such as that shown in FIG. 1;

FIG. 7 is a perspective view of an attachment system that is attached to an end of a telescopic device, such as that shown in FIG. 1;

FIG. 8 is a perspective view of an attachment actuation mechanism, such as that shown in FIG. 7;

FIG. 9 is a profile view of a housing a telescopic stick attachment boxes and attachment box mechanism in accordance with an embodiment of the present disclosure;

FIG. 10 shows a top, transparent view of the attachment box mechanism, such as that shown in FIG. 9, having a hammer and catcher;

FIGS. 11 and 12 are cross-sectional views of an attachment mechanism, such as that shown in FIG. 10, that is in unlocking and locking positions;

FIG. 13 has a side view and a perspective view of a frame and bag attachment, such as that shown in FIG. 4, that is in a closed position;

FIG. 14 is a perspective view of a frame and bag attachment, such as that shown in FIG. 4, in an opened position;

FIG. 15 is a perspective view of a rake attachment in a closed position; and

FIG. 16 is a perspective view of a rake attachment, such as that shown in FIG. 15, that is in an open position.

### DETAILED DESCRIPTION

Exemplary systems are discussed with reference to the figures. Although these systems are described in detail, they are provided for purposes of illustration only and various modifications are feasible.

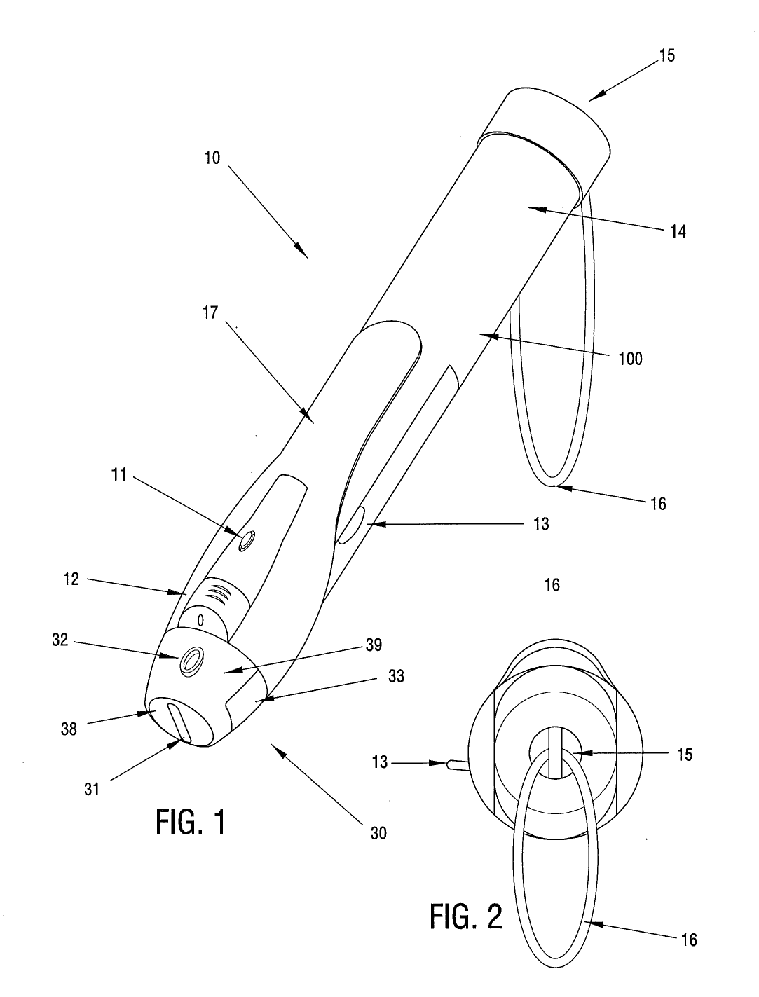

FIG. 1 is a perspective view of a telescopic device 100 in its compact form 10 in accordance with the present disclosure. In this figure, the telescopic device 100 is in its compact form 10. The telescopic device 100 can be anywhere between 6-24 inches in compact form 10 and 3-7 feet in extended form, though there are no limits on its length of compactness or extension.

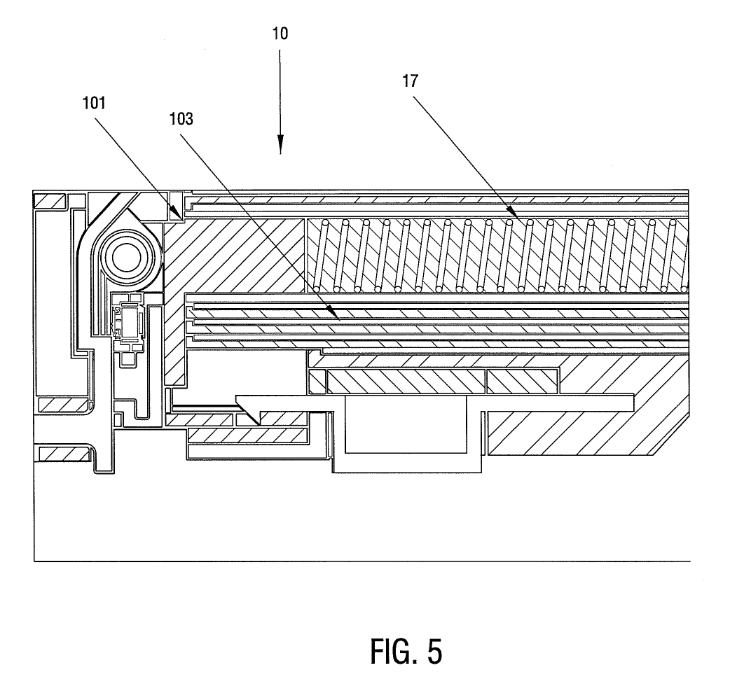

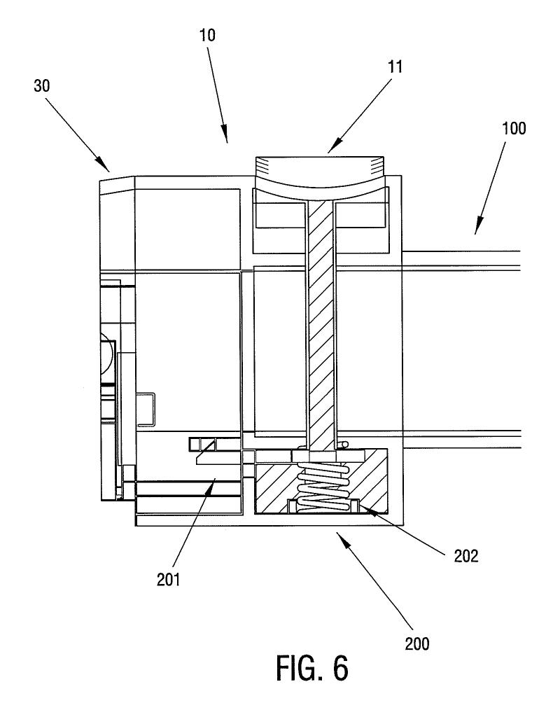

The telescopic device 100 has an opening, closing, and locking mechanism 200 (FIG. 5) that is controlled by a opening button 11 that extends a telescopic stick 101 (FIG. 4) when actuated. The telescopic stick 101 can be folded telescopically internally to a housing 17, which can be used as a handle. The telescopic stick 101 can be configured to fully and entirely house in the housing 17 in a closed position. In a retracted position, the telescopic stick 101 can be relocked and stored in the housing 17 by the opening, closing, and locking mechanism 200 of the telescopic device 100. The opening, closing, and locking mechanism 200 is further described in FIG. 5.

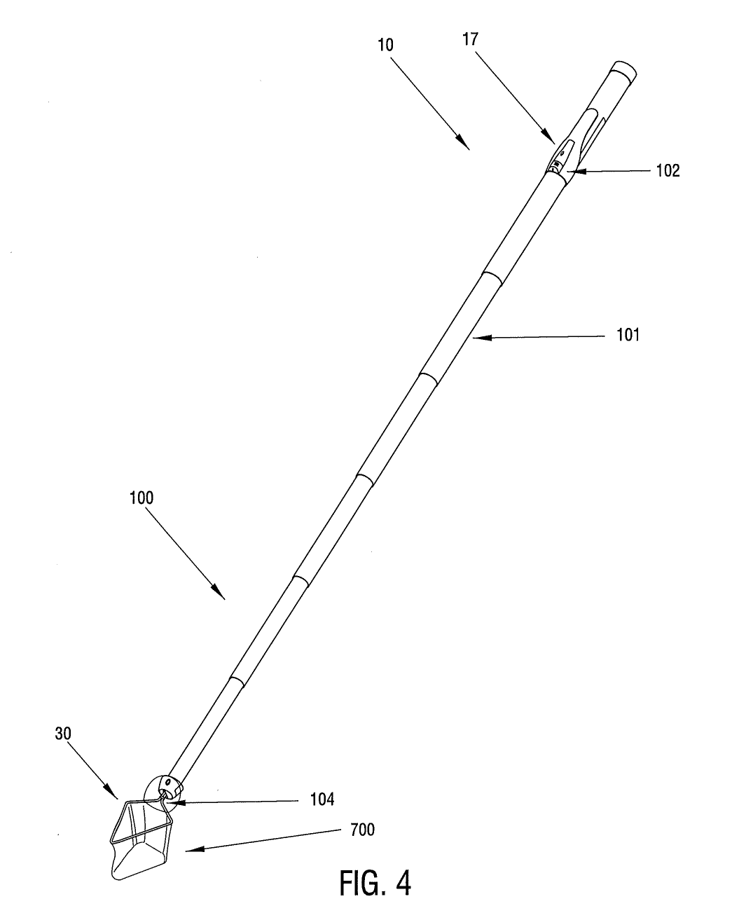

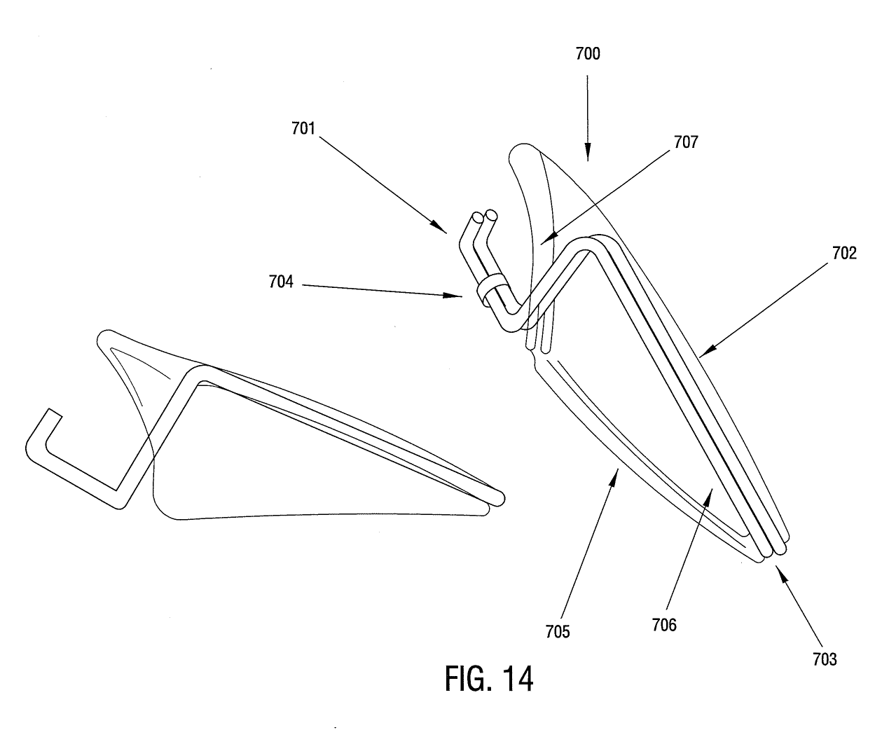

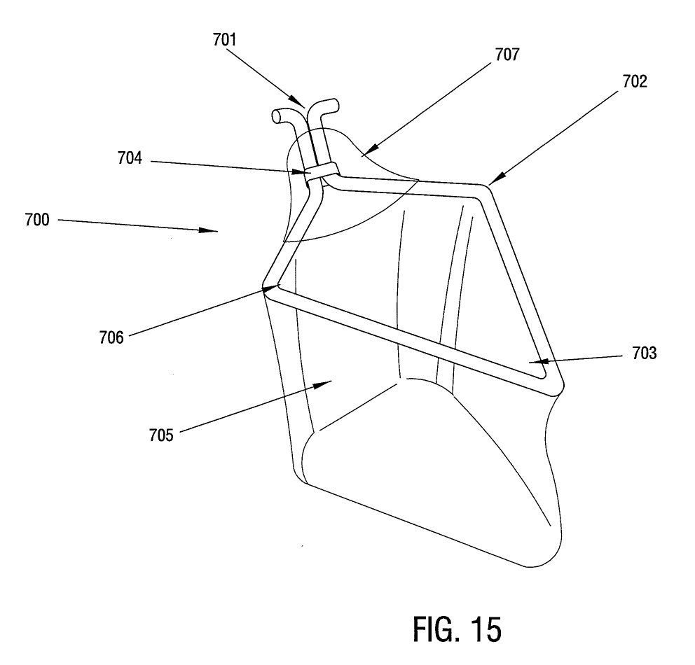

The telescopic device 100 can includes an attachment system 30 that provides a slot 31 for attaching an attachment (e.g., a rake attachment 800 (FIG. 15), frame and bag attachment 700 (FIG. 14), etc.) to the telescopic stick 101, of which then the attachment 700 can be used in conjunction with the telescopic stick 101 in compact form 10, or extended form (shown in FIG. 4). The user takes an attachment 700, for example a frame and plastic bag attachment 700, and inserts it into the slot 31 of the attachment system 30. This is represented in FIG. 3 depicting the disclosure in compact form 10 with a frame and bag attachment 700 inserted to the slot 31 in the frame and bag's closed state.

The telescopic device 100 can include a retraction pull back area 33 on the outsides of the attachment system 30. This retraction pull back area 33 includes a small depression, that can be the size of a finger tip, with an indentation with small raised bumps so a user can better target, grip the attachment system 30 and pull back the telescopic stick 101 from its extended position (shown in FIG. 4) to its compact position 10.

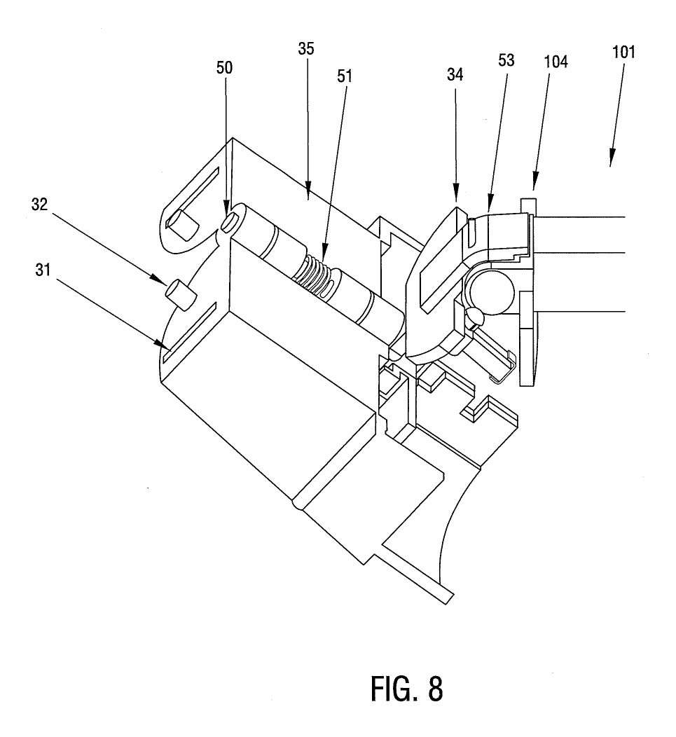

The attachment system 30 includes a left attachment box 39 and right attachment box 38 by the actuation mechanism 35 that can automatically split into halves and tilt up toward an angle of roughly 40 degrees by the attachment box tilting mechanism 34 (FIG. 7). This tilting angle of the attachment system 30 allows a user to automatically position the frame and bag attachment 700 to lie parallel to the ground while in use. Since the user is holding and pointing the telescopic device 100 at an angle toward the ground, in the case of catching dog waste, a user can open the telescopic device 100, extend the telescopic stick 101, and the frame and bag attachment 700 would be opened and positioned at an angle. The user can then slide the frame and bag attachment 700 under the dog while the dog is defecating as the user is standing straight up.

The user can then detach the frame and bag attachment 700, or any other attachment, by pressing the release button 32. The user is able to detach any attachment at any time during the attachment's insertion in the attachment system 30 (during the telescopic device 100 closed and compact state 10 or in its extended state as depicted in FIG. 4).

The telescopic device 100 can further include a light source 12 for use at night and in dark areas. The light source 12 can include an LED light that can be attachable and detachable to the housing 17 in the event that the user needs to replace the light's batteries or replace the light in its entirety due to damage. The light source 12 can be water proof having a soft plastic and rubber cover film, as opposed to a button, that turns the light on and off. The soft plastic and rubber cover film is to provide better functionality and aesthetic appeal of the product. The light source 12 can house two (2) batteries and one (1) bulb, but can be operational with any number or types of bulbs and batteries, and at any level of radiance.

The telescopic device 100 can further include a carrying mechanism 13 to allow a user to attach the telescopic device 100 to any type of object such as a dog leash, piece of clothing, a purse, or other type material for better portability and handling when in storage or in use. The carrying mechanism 13 includes a door like opening from the housing 17, and an internal rib structure to allow the fitting of any type material, such as a leash or an article of clothing. The housing 17 can include an attachment carrying mechanism 14 which allows a user to carry an attachment 700 before or after its use. The attachment carrying mechanism 14 is a thin hallowed part of the handle which allows you to slide an attachment—rake or frame and bag onto the handle, so it acts like a storage mechanism

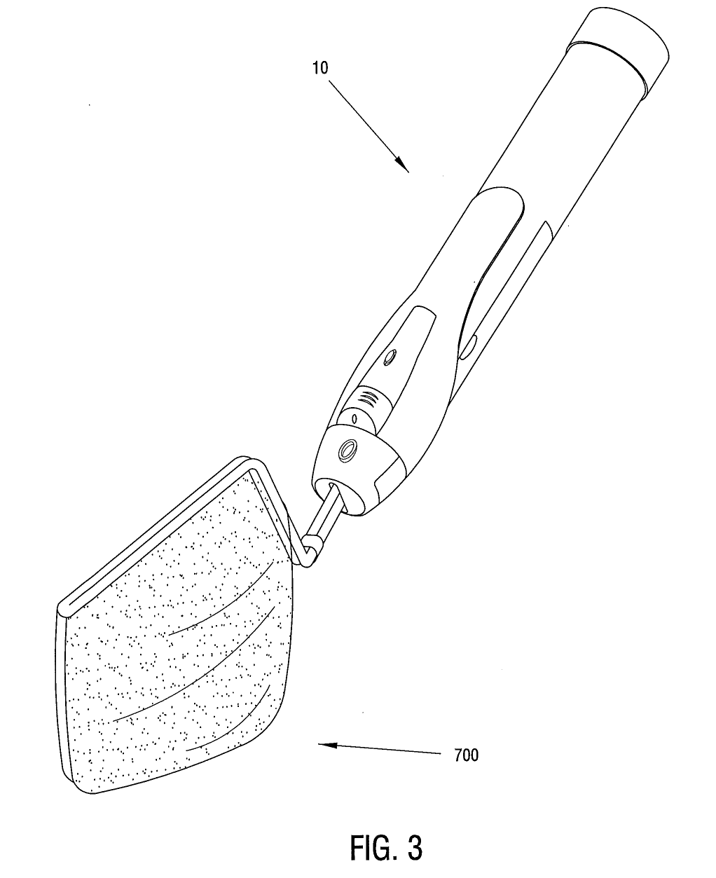

FIG. 2 is a rear view of a telescopic device 100, such as that shown in FIG. 1. The housing 17 has a wrist holder 16 and wrist holder attachment 15 to provide additional methods of carrying or holding the telescopic device 100 while in use.

As mentioned above, FIG. 3 depicts the telescopic device 100 in compact form 10 with a frame and bag attachment 700 inserted to the attachment mechanism 30 in the frame and bag's closed state.

FIG. 4 is a perspective view of a telescopic device 100, such as that shown in FIG. 3, in its extended form having a frame and bag attachment 700. The telescopic device 100 includes the telescopic stick 101 that includes multiple tube segments that can be made of 4-6 hollow oval aluminum segments that fold within each other. Each tube segment is smaller in diameter than the other. The largest diameter tube segment can be 0.75 inches to allow for a narrow holding and gripping housing 17 by a user. The tube can be made of aluminum to provide a lightweight and durable telescopic device 100 which can be used in all weather conditions, and provides easy portability.

The telescopic stick 101 can, however, be made of any material including, but not limited to aluminum, plastic, wood or other material. The tube segments can be in and oval shape so they can be prevented from rotating around each other. Preventing the telescopic stick system 100 from rotating can allow a user to use an attachment 700 in a targeted approach where the attachment 700 does not flip, rotate around, or turn upside while in use, or while the telescopic stick 101 is being opened.

While the shape of the tube segments prevent the rotation of the telescopic stick 101, any other method, automatic or manual, such as internal or external locking joints or channels used to create the same affect can be employed for the use of the telescopic device 100. In short, the telescopic stick 101 can have non-rotational features that may be constructed by internal or external mechanisms or through the shape of the telescopic stick segments. In addition, the telescopic stick 101 can have telescopic stick locking features (not shown) at the overlap of each tube segment that automatically creates and allows the telescopic stick 101, to maintain and hold its position in an extended state. In general, the telescopic stick 101 can have manual or automatic locking, lock-like, or sticky features allowing the telescopic stick 101 to maintain a compact or extended position while at rest or in use.

When the user is ready to recoil the telescopic stick 101, the user can recoil the stick without having to manipulate the stick to unlock the telescopic stick locking feature other than just by physically retracting the telescopic stick system 100. A user can use an attachment 700 at an extended position without the telescopic stick 101 recoiling or moving back up toward the handle while in use. While an internal telescopic stick locking feature can used, any other method, automatic or manual, such as internal or external locking joint or channel, creating the same affect can be employed.

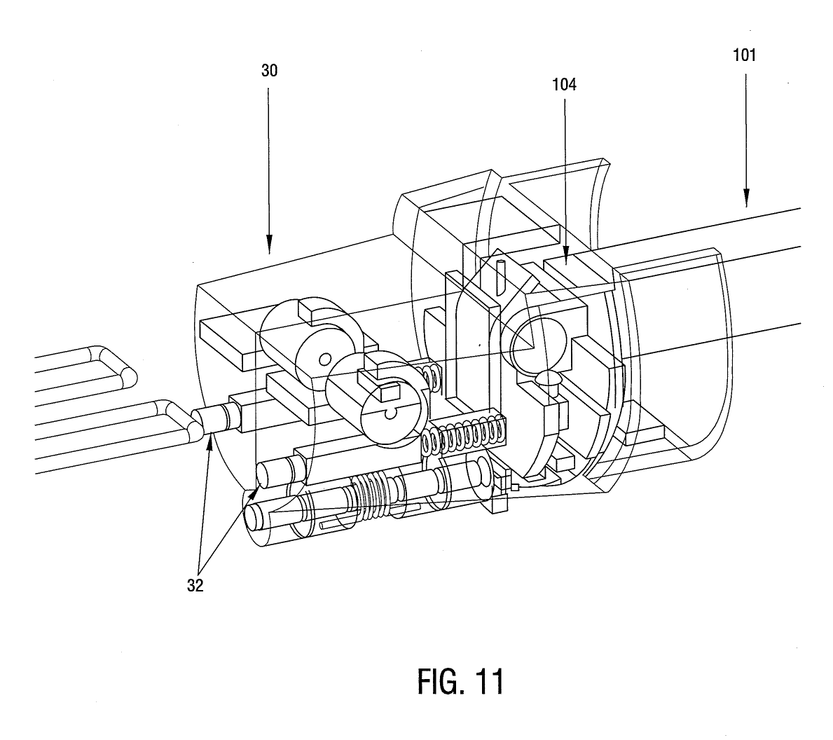

Alternatively or additionally, the last, outer segment of the telescopic stick 101 slides through the internal handle and latches onto a telescopic stick catch 102. This feature allows additional extendable reach of a compact stick system, while using the handle as an additional, or last, segment to the telescopic stick 101, while maintaining a slender housing 17. The telescopic stick 101 is also attached to the attachment system 30 via an attachment joint 104, which is further described and shown in FIG. 10.

Alternatively or additionally, the housing 17 can have an automatic retraction system (not shown) powered by a motor and batteries, mechanical pulley system, or other such mechanism that allows the user to retract the telescopic stick 101 back into the housing 17, by pressing a button (not shown) on the housing 17. The button can also automatically opens and closes the attachment 700 from its open or closed position, where by such button releases a pulley mechanism (not shown) made of strings and pulleys that automatically closes the attachment 700. Alternatively or additionally, the telescopic device 100 can further include an attachment opening button (not shown) where a user presses the button on the housing 17 to trigger a spring and hammer unlocking system (not shown) that opens the attachment 700 while the attachment 700 is in the housing 17 still in its compact form 10.

FIG. 5 is a cross-sectional view of a telescopic stick spring system 200 housed in a telescopic device 100, such as that shown in FIG. 1. A user can press the button 11, which in turn presses against a spring 202 that drops down a locking joint 201, thus releasing and extending the telescopic stick 101. The pressing of the button 11 allows the user to extend the telescopic stick 101 to its desired length of use (e.g., from partially to fully extended) and targeted function such as catching a dog's waste in the disclosure's frame and bag attachment 700, without having to bend over.

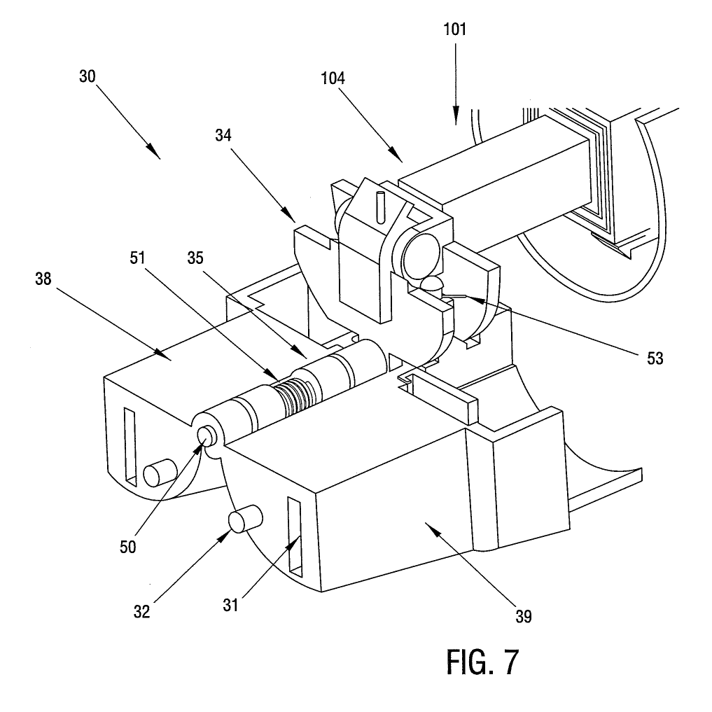

FIG. 6 is a cross-sectional view of an opening mechanism of a telescopic device 100, such as that shown in FIG. 1. As mentioned previously, the telescopic stick 101 can be folded and housed in the housing 17. The telescopic device 100 can include a springing mechanism 103 that pushes the attachment system 30 and telescopic stick 101 out of the handle with some immediacy, so a user can use the attachment for any application in an instant manner. Such as the case in catching dog waste, users may be time sensitive and have a short time to set up and catch their dog's waste, thus the need for a more immediate extension of the telescopic stick 101 and its attachment.

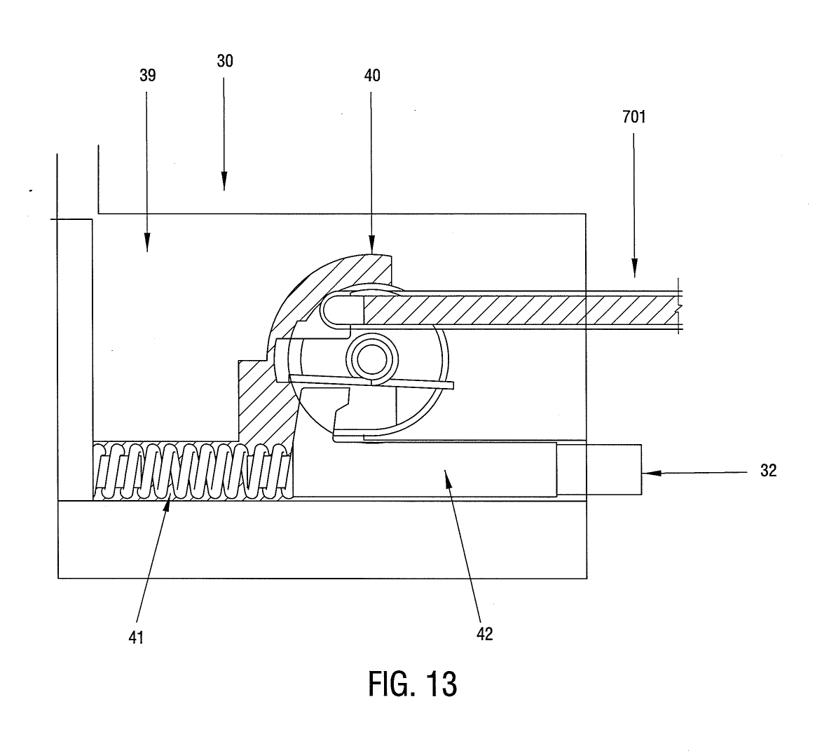

FIG. 7 is a perspective view of an attachment system 30 that is attached to an end of a telescopic device 100, such as that shown in FIG. 1. An attachment, such as the frame and bag attachment 700, can be inserted into the slot 31 and locked on the attachment system 30 when the attachment 700 is pushed farther enough therein. A release button 32 can release or unlock the attachment 700 when pressed upon. Upon the extending the telescopic stick 101, the attachment system 30 automatically splits into halves by the attachment actuation mechanism 35, separating into a left attachment box 39 and right attachment box 38. This splitting of the left attachment box 39 and right attachment box 38, opens up the frame and bag attachment 700 from its closed position as depicted in FIG. 4 where the telescopic stick 101 is extended and the frame and bag attachment 700 move from a closed to open position. The frame attachment's opening and closing can also be depicted in FIG. 13 and FIG. 14.

The left attachment box 39 and right attachment box 38 includes barrels in which a rod 50 is passed there through. The attachment actuation mechanism 35 include a spring 51 in which the rod 50 is passed there through and is located between the barrels of the left attachment box 39 and right attachment box 38. The spring engages and automatically opens the left attachment box 39 and right attachment box 38 responsive to the telescopic stick 101 being extended.

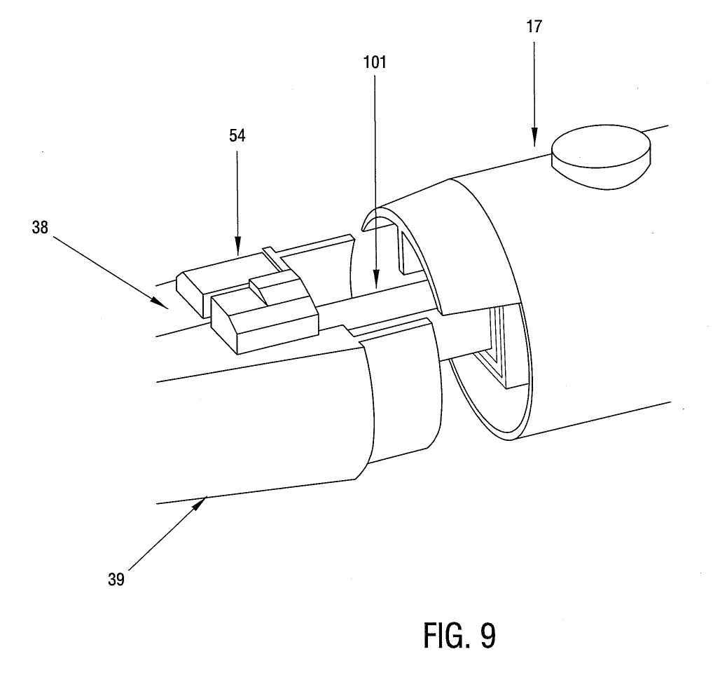

In addition to the attachment system 30 splitting into halves, the left attachment box 39 and right attachment box 38 tilt up toward an angle of roughly 40 degrees by the attachment box tilting mechanism 34, automatically, which is shown in FIG. 8. This tilting angle of the attachment system 30 allows a user to automatically position the frame and bag attachment 700 to lie parallel to the ground while in use. The tilting angle of the attachment system 30 is achieved by a hinge pivot and spring mechanism 53 that is prepositioned to open at a 40 degree angle. Upon opening the telescopic stick 101, the hinge pivot and spring 53 automatically opens to a predisposed position of 40 degrees. Since the user is holding and point the disclosure at an angle toward the ground, in the case of catching dog waste, a user can open the disclosure, extend the telescopic stick 101, and the frame and bag attachment 700 would be open, and positioned at an angle, whereby the user can then slide it under the dog while the dog is defecating while standing straight up.

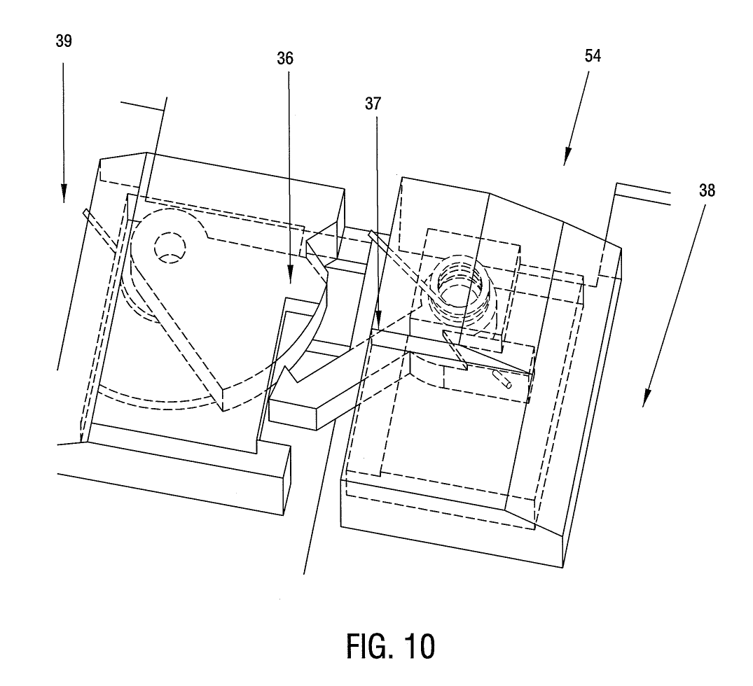

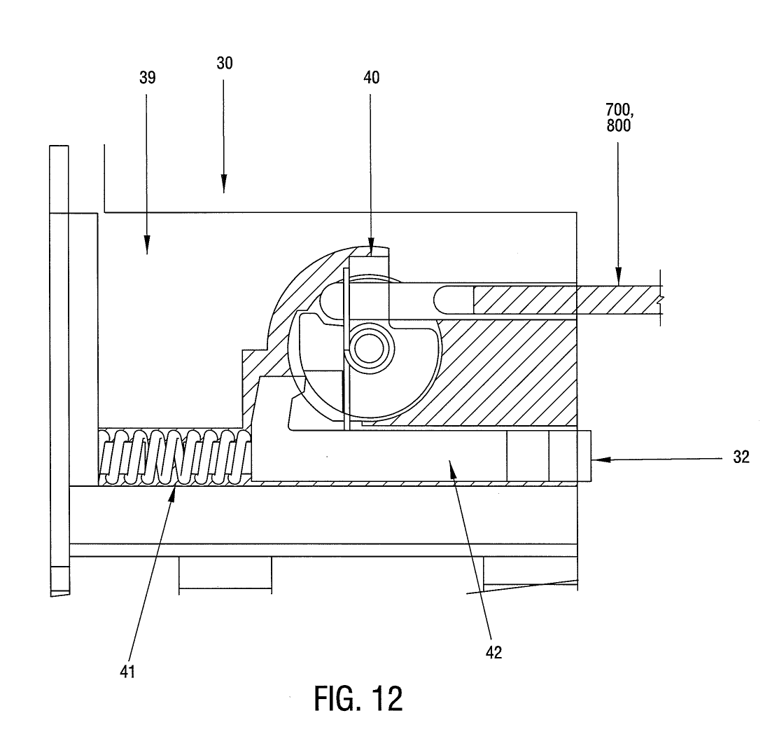

FIG. 9 is a profile view of a housing 17, a telescopic stick 101, attachment boxes 38, 39, and attachment box mechanism 54 in accordance with an embodiment of the present disclosure. The telescopic stick 101 can extend outward from the housing 17. The attachment boxes 38, 39 are attached at the end of the telescopic stick 101. In this example, the attachment box mechanism 54 is attached on the top outer surface of the attachment boxes 38, 39. The attachment box mechanism 54 can be located anywhere on the attachment boxes 38, 39. The general purpose of the attachment box mechanism 54 is to allow a user to close the boxes after use. The attachment box mechanism 54 is further described in connection to FIG. 11.

FIG. 10 shows a top, transparent view of the attachment box mechanism 54, such as that shown in FIG. 9, having a hammer 37 and catcher 36. After a user uses the desired frame and bag attachment 700, the user can then reclose the attachment boxes 38 and 39, with the attachment box mechanism 54 that includes of a hammer 37 and catcher 36. The closing of the attachment boxes 38 and 39 allows a user to close the frame and bag attachment 700, prior to the recoiling of the telescopic stick 101. This allows a user to close the dog waste, or other refuse collected in the frame and bag attachment 700, prior to retracting the telescopic stick 101. The hammer 37 and catcher 36 also releases upon the initial opening of the telescopic stick 101, so the attachment boxes 38, 39 can split into halves. Upon the insertion of the telescopic stick system 100 and attachment system 30 back into the housing 17, the hammer 37 and catcher 36 are reset to open again upon the next time of use. The hammer 37 is coupled to a spring system that urges the hammer 37 to lock onto the catcher 36. Upon inserting the attachment system 30 back into the housing 17, the hammer 37 and catcher 36 are released inside the housing 17, as it presses against a small piece of plastic in the inner part of the housing 17, which is then allows the attachment boxes 38, 39 to open up again upon next use.

In its compact state 10, the attachment system 30 consists of a spring 41 that is in a compressed form and sits against a hammer 42 and release button 32. A user inserts the joint 701 of the attachment 700 which pushes a wheel 40 in a counter clockwise manner. The wheel 40 rotates until a part of the wheel 40 catches onto a hook on the hammer 42, which extends the spring 41 and thus locking the attachment 700 into the attachment system 30. To release the attachment 700 from the attachment system 30, the user can push the release button 32 that compresses the hammer 42 against the spring 41, thus allows the hook on the hammer 42 to release from the wheel 40, and thus allowing the attachment 700 to be released from the attachment system 30.

FIGS. 11 and 12 are cross-sectional views of an attachment mechanism 30, such as that shown in FIG. 10, that is in unlocking and locking positions. The user achieves locking the frame and plastic bag attachment 700 by, inserting the end of the frame and bag's attachment joint 701 of the frame and plastic bag attachment 700 into the slot 31 (FIG. 1), and pushing the frame and bag's attachment joint 701 into an attachment system 30 as depicted in FIG. 11 and FIG. 12. FIG. 11 demonstrates the attachment mechanism 40 prior to the insertion of the frame and bag's attachment joint 701. FIG. 12 demonstrates the attachment system 30 with the insertion of the frame and bag's attachment joint 701.

The user can then detach the frame and bag attachment 700, or any other attachment, by pressing the release button 32 which pushes the hammer 42 against the spring 41, and automatically rolling the wheel 40, back to its original position. The user is able to detach any attachment at any time during the attachment's insertion in the attachment system 30 (during the closed and compact state 10 or in its extended state of the telescopic device 100).

After the user inserts the frame and bag attachment 700 into the attachment mechanism 30 and it is locked in, the user can push the opening button 11 which then extends the telescopic stick 101. Note that the attachment system 30 is attached to the telescopic stick 101 at the end of the last segment of the telescopic stick system 100 by a joint 104, as depicted in FIG. 4.

FIG. 13 has a side view and a perspective view of a frame and bag attachment, such as that shown in FIG. 4, that is in a closed position. The frame and bag attachment 700 has a frame and bag attachment joint 701 that inserts and locks into the attachment system 30. This attachment joint 701 is also a universal joint for the any type of attachments, allowing different attachments (e.g., a rake attachment or a mop attachment) with a joint similar to that of 701 to lock and fit into the attachment system 30.

The frame and bag attachment 700 has a frame 702 that can be made of metal, wood, paper, plastic, or other material that can open and close the bag 705. The frame 702 can be made of solid or non-solid frame, multiple open parts, or have an open segment or pivot area, or a frame pivot 703, that allows the frame and bag attachment 700 to open and close using the attachment system 30.

The frame also has a coupling attachment 704 (e.g., a clip) that keeps the frame together, and allows the frame to pivot in the attachment system 30. The bag 705 has a slit 706 of which the frame can be inserted into, such that the bag 705 slides into the frame 702. The bag 705 is also attached to the frame 702 with a bag-to-frame attachment 707 which allows the bag to be attached to the frame while in storage and use. The bag 705 can also be detached if a user desires to pull the bag 705 off the frame 702 after use. While the bag 705 can be slid over the frame 702, the bag can also be directly attached or glued to the frame itself.

The frame and attachment 700 allows a greater degree of user convenience in that the user can insert various frame and bag attachments to use with the telescopic device 100, and dispose of it after use. The frame 702 has the strength and firmness that allows a user to hold the frame and bag attachment 700 down, and flush to the ground so it can be used to collect debris. In the case of catching dog waste, the frame allows the bag to lay flat to the ground so the dog may defecate directly into the bag. Many dogs crouch and defecate very close to the ground (less than an inch), thus having the ability to slide and maneuver the frame and bag attachment 700 underneath the dog, flat to the ground, is a desirable feature and a basis of the frame and bag attachment's design 700. FIG. 14 depicts a preassembled frame and bag attachment 700, in an open position. The frame 702 may also be made of any shape including but not limited to being triangular, oval, round, or other shape.

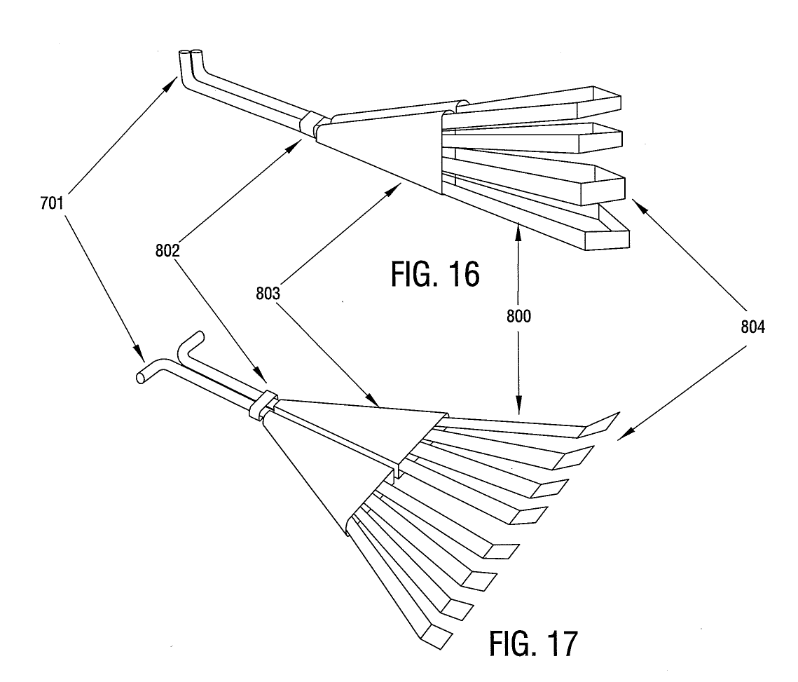

FIGS. 15 and 16 are perspective views of a rake attachment 800 in a closed position and open position, respectively. The rake attachment 800 includes a rake attachment joint 701 that is a universal joint similar to that of the frame and bag attachment 700. The rake attachment 800 includes a coupling attachment 802 that allows the different halves of the rake attachment 800 to open and close. A solid base 803 is connected near the rake band pivot 802, and teeth 804 that allows for raking and scooping of material. The rake attachment 800, and any of its component pieces may be made of any or multiple materials including wood, plastic, metal, or any other materials and could include the use of an additional plastic bag type material to cover the rake.

A user can use two telescopic devices, e.g., one with a rake attachment 800 and one with a frame and bag attachment 700, to be used in conjunction with each other such that the user rakes debris or collect dog waste with the rake attachment 800 attached to a first telescopic device into a frame and bag attachment 700 attached to a second telescopic device.

In general, the attachments 700, 800 includes an interface portion 701 and a functional portion. The interface portion 701 is coupled to the attachment system 30 and the functional portion (e.g., bas or claws of the rake) is connected to the interface portion 701, The functional portion of the functional attachment is used for collection and clean purposes. The attachment 700, 800 can be a cohesive one piece collection device that inserts and works with the attachment mechanism 30.

Alternatively or additionally, the housing 17, which can be made of light, durable plastic, has a diameter of roughly 1.5 inches, and houses the telescopic stick 101. The housing 17 is ergonomically designed to allow a user to better position and grip the housing 17 in the user's hand. In addition the handle has a special texture and added sprays to improve its grip by a user. The housing 17 can, however, be made of any type of material including rubber, plastic, or other synthetic material that provides a similar function and gripping methods.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

Therefore, having thus described the disclosure, at least the following is claimed:

1. A telescopic device comprising:
a housing;
a telescopic stick that is configured to house in the housing in a closed position, wherein the telescopic stick includes one or more segments that is configured to extend into an elongated stick in an extended position; and
an attachment system that is attached to an end of the telescopic stick, wherein the attachment system includes a locking mechanism that locks and unlocks an attachment to the telescopic stick, wherein the attachment system further includes an attachment actuation mechanism that opens and closes the attachment.

2. The telescopic device of claim 1, wherein the attachment system further includes attachment box tilting mechanism having a hinge pivot and spring mechanism that is prepositioned to open the attachment at a desired position or angle.

3. The telescopic device of claim 1, wherein the housing includes a light source that provides illumination for the use of the telescopic stick and the attachment prior, during, and after the use of the attachment.

4. The telescopic device of claim 1, wherein the housing is a handle and includes at least one of the following:
a carrying mechanism that allows the telescopic device to be attached to another object for the ease of carrying, transporting, using, and storing the telescopic stick;
a holder that allows the telescopic stick additional carrying, transportation, use and storage features; and
an attachment storage system that allows the storage of the attachment prior, during, and after the use of the telescopic stick.

5. The telescopic device of claim 1, further comprising an opening and closing system of the telescopic stick that allows the telescopic stick to maintain a compact closed position when at rest, and the extended position when in use.

6. The telescopic device of claim 1, wherein the attachment includes at least one of the following: dog waste bag and frame, rake, broom, mop, hoe, and cleaning pad, where the attachment is inserted into the attachment system and actuates accordingly to the attachment actuation mechanism.

7. The telescopic device of claim 1, wherein said telescopic stick has non-rotational features that may be constructed by internal or external mechanisms or through the shape of the telescopic stick segments.

8. The telescopic device of claim 1, wherein said telescopic stick has manual or automatic locking, lock-like, or sticky features allowing the telescopic stick to maintain a compact or the extended position while at rest or in use.

9. The telescopic device of claim 1, wherein said attachment system includes a locking and unlocking mechanism for partial or full insertion of various attachments into the telescopic stick, wherein the locking and unlocking mechanism includes at least one of the following: natural friction, manual and automatic means, the attachment system being attached onto, or attachable and detachable, to the telescopic stick.

10. A multifunctional telescopic device comprising:
a telescopic stick that includes one or more segments that is configured to extend into an elongated stick in an extended position; and
an attachment system that is attached to an end of the telescopic stick, wherein the attachment system includes a locking mechanism that locks and unlocks an attachment to the telescopic stick; and
at least one functional attachment that includes an interface portion that is coupled to the attachment system and a functional portion that is connected to the interface portion, wherein the functional portion of the functional attachment is used for collection and clean purposes.

11. The multifunctional telescopic device of claim 10, wherein the at least one functional attachment includes at least one of the following: dog waste bag and frame, rake, broom, mop, hoe, and cleaning pad, where the attachment is inserted into the attachment system and actuates accordingly to an attachment actuation mechanism.

12. The multifunctional telescopic device of claim 10, wherein the attachment is a cohesive one piece collection device that inserts and works with the attachment system.

13. The multifunctional telescopic device of claim 10, wherein the attachment system includes left and right attachment boxes that include respective slots for the at least one functional attachment to be inserted into thereof.

14. The multifunctional telescopic device of claim 13, wherein the attachment system further includes an attachment actuation mechanism that engages and automatically opens the left attachment box and right attachment box responsive to the telescopic stick being extended.

15. The multifunctional telescopic device of claim 13, wherein the attachment system further includes an attachment box tilting mechanism that automatically positions the at least one functional attachment to lie parallel to the ground while in use.

16. A collection and cleaning device comprising:
a telescopic stick includes one or more segments that is configured to extend into an elongated stick in an extended position; and
an attachment system that is attached to an end of the telescopic stick, wherein the attachment system includes a locking mechanism that locks and unlocks an attachment to the telescopic stick; and
at least one functional attachment that includes an interface portion that is coupled to the attachment system and a functional portion that is connected to the interface portion, wherein the functional portion of the functional attachment is used for collection and clean purposes; wherein the at least one functional attachment includes one of the following: dog waste bag and frame, rake, broom, mop, hoe, and cleaning pad, where the attachment is inserted into the attachment system.

17. The collection and cleaning device of claim 16, wherein the attachment is a cohesive one piece collection device that inserts and works with the attachment system.

18. The collection and cleaning device of claim 16, wherein the attachment system includes left and right attachment boxes that include respective slots for the at least one functional attachment to be inserted into thereof.

19. The collection and cleaning device of claim 18, wherein the attachment system further includes an attachment actuation mechanism that engages and automatically opens the left attachment box and right attachment box responsive to the telescopic stick being extended.

20. The collection and cleaning device of claim 16, wherein the attachment system further includes an attachment box tilting mechanism that automatically positions the at least one functional attachment to lie parallel to the ground while in use.
